(19) United States
(12) Patent Application Publication
(10) Pub. No.: US 2022/0395061 A1
(43) Pub. Date: Dec. 15, 2022

(54) DEEP-DRAWN SEGMENT

(71) Applicant: SYMPATEX TECHNOLOGIES GMBH, Unterföhring (DE)

(72) Inventors: Martin MAYERSHOFER, Scheuring (DE); Mhamed MOUHASSIN, München (DE)

(73) Assignee: SYMPATEX TECHNOLOGIES GMBH, Unterföhring (DE)

(21) Appl. No.: 17/765,278

(22) PCT Filed: Sep. 30, 2020
(86) PCT No.: PCT/EP2020/077359

§ 371 Date: Mar. 30, 2022

(30) Foreign Application Priority Data
Oct. 1, 2019 (EP) 19200907.4

(51) Int. Cl. A43B 23/02; B29D 35/14; B29C 51/14; B29C 51/08; B29C 51/10; B29C 51/00; B29D 35/12; B32B 7/14; B32B 27/12; B32B 5/02; B32B 27/28; B32B 37/10; B32B 37/12; B32B 5/26

(52) U.S. Cl. CPC A43B 23/022; B29D 35/146; B29C 51/145; B29C 51/08; B29C 51/10; B29C 51/004; B29D 35/126; B32B 7/14; B32B 27/12; B32B 5/026; B32B 27/285; B32B 37/1018; B32B 37/1207; B32B 5/022; B32B 5/279; B29K 2995/0065; B29K 2995/0069; B29K 2313/00; B29L 2031/505

(57) ABSTRACT

A method for producing a water-tight, water-vapour-permeable segment, having a three-dimensional contour, for a shoe shaft, an item of clothing or a rucksack or for producing a shoe shaft, an item of clothing or a rucksack, the segment being free of connection points in its surface, and the method for producing the segment being a thermoforming process in which the two-dimensional flat structure obtained is completely laminated in its entirety, the segment being free of connection points in its surface. Also, a water-tight, water-vapour-permeable segment of a three-dimensional functional laminate for introduction into a shoe or shoe shaft, an item of clothing or a rucksack, the segment being dimensionally stable under its own weight, of a single piece and free of connection points in its surface.

The invention relates to a method for producing a water-tight, water-vapour-permeable segment, having a three-dimensional contour for introduction into a shoe shaft, an item of clothing or a rucksack or for forming said contour, and to such a segment.

The outer layer (upper) of a water-tight and water-vapour-permeable shoe shaft typically consists of a water-permeable or water-repellent and air-permeable material, for example leather or a textile ply. In order to make the shoe shaft water-tight, a water-tight and water-vapour-permeable ply, which can be for example a monolithic or porous membrane, is used on the inside of the upper. This water-tight and water-vapour-permeable ply, generally referred to as the “functional layer”, may have a protective or reinforcing ply on one or both sides. The composite of “functional layer” and protective or reinforcing ply is then generally referred to as “functional laminate”.

Water-tight and water-vapour-permeable top and bottom coverings are constructed in an entirely analogous manner. The outer layer in outerwear, for example, is often made of robust fabric and provides protection against the wind and weather. Towards the inside, there are usually one or more layers of wool or fleece, for example, which protect the body against the cold, for example. In order to make the item of clothing water-tight, a water-tight and water-vapour-permeable ply, which can be for example a monolithic or porous membrane, is again arranged as a functional layer as one of the (inner) layers. As in a shoe, the functional layer can also be provided with a protective or reinforcing ply on one or both sides in items of clothing, as a functional laminate.

A functional laminate as described above is also known from other textile applications, such as rucksacks, where the laminate structure consisting of a soft functional layer and a protective or reinforcing ply ensures a level of wear comfort and optimum load distribution.

A whole range of materials for functional layers is known to the person skilled in the art. Examples of functional layer materials are polyether esters (PEEST), polyurethanes (PU), polyether amides (PEA) and polyhaloolefins.

A particular challenge here is to adapt the functional laminate to the contour of a body part in optimum fashion, e.g. to the shape of the foot.

It should be noted at this point that the following description of the present invention is only given by way of example using a shoe, but that the embodiments are of course not to be understood as being limited to this, but can also be applied to other items of clothing (e.g. jackets, trousers, shirts or parts thereof) and accessories (e.g. caps, gloves, rucksacks), where an optimised three-dimensional or seam-free or at least seam-reduced contour would appear to be useful, without departing from the intended scope of protection.

The functional laminate is therefore usually composed of several two-dimensional, planar parts in order to obtain a reasonably accurately fitting three-dimensional structure. For example, in the case of a shoe, the three-dimensional structure is usually connected at the top of the shaft and at the sole. Since the functional layer no longer exhibits water-tightness, or the latter is at least decreased, at the connection or seam points, the connection or seam points must usually be subsequently sealed using a seam sealing tape. The seam sealing tapes known to the person skilled in the art, which cover the functional layer in the area of the connection or seam points, are usually not water-vapour-permeable. This reduces the active surface available for the removal of moisture from the inside of the shoe in the area of the shoe shaft and prevents the passage of water vapour, which is essentially desirable, in the areas of the sealed connection points or seams, thereby reducing the climate comfort of the shoe.

Furthermore, the steps of sewing or joining functional laminates and the subsequent sealing of the connection points thereby obtained in the production of three-dimensional water-tight and at the same time water-vapour-permeable shoes constitute comparatively complex and labour-intensive processes, as often reflected in comparatively high production costs of such shoes.

As explained above, the same or analogous considerations also apply to other forms of application of functional laminates, such as in the items of clothing or rucksacks mentioned above.

In addition, the functional laminate may be weakened by the necessary introduction of seams or connection points at these places and thereby prematurely lose its integrity under load.

Another known problem occurring in shoes with functional laminates introduced in this way is the lack of wear comfort due to insufficient fit. By assembling the three-dimensional structure from two-dimensional, planar individual parts, the required three-dimensional contour can only be approximately achieved. This can cause wrinkles in places where there is too much material and pressure points in places with too little material, which can significantly worsen the wear comfort of a water-tight and water-vapour-permeable shoe, for example.

US 2015/0230553 A1 discloses a water-tight and water-vapour-permeable functional sock (bootie) made of expanded polytetrafluoroethylene (ePTFE), which is seamless but has connection points.

US 2015/0150335 A1 discloses a footwear system comprising a water-tight functional sock (bootie). This functional sock (bootie) is produced by means of a casting process and is not water-vapour-permeable.

EP 1 212 953 B1 discloses a shoe construction with a functional layer shaft. This functional layer shaft is water-tight and water-vapour-permeable and is obtained by coating a three-dimensional foot contour or a three-dimensional sock structure. US 2017/0042280 A1 discloses a water-tight and water-vapour-permeable functional sock (bootie). This functional sock contains at least one textile ply and a seamless and stretchable functional layer. The textile ply or plies is (are) provided as a three-dimensional sock and is (are) applied to a last together with the functional layer. These plies are connected to each other with an adhesive, for example, to form a functional laminate and then fixed in their shape with heat. The functional sock (bootie) made in this way encloses the entire foot of the shoe wearer.

A disadvantage with US 2017/0042280 is that the functional laminate encloses the entire foot of the shoe wearer, in particular the sole part. For this reason, certain techniques for connection to a sole, e.g. by means of Strobel seam or pinching, are not readily possible here.

Another disadvantage of US 2017/0042280 is that the method for producing such a functional sock (bootie) is comparatively cumbersome and time-consuming due to the successive application of individual layers to the last.

Furthermore, the method described in US 2017/0042280 of successively applying different layers to produce a functional sock (bootie) involves the risk of wrinkling, which can limit the comfort of the shoe.

The document DE 39 37 106 A1 discloses a method for producing a single-piece seamless shoe lining shaft by thermal deformation of a laminate. The shoe lining shafts produced in this way exhibit a processing shrinkage of up to 10%.

A disadvantage of DE 39 37 106 A1 is that the laminate to be converted into a three-dimensional contour by thermal deformation must be produced in a preceding (possibly multi-stage) process step by methods known to the person skilled in the art of connecting the textile ply and the functional layer, for example by means of point or grid-type bonding using reactive, moisture-crosslinking PU hot-melt adhesives. This can increase the effort involved in terms of plant engineering and logistics, which in turn can have a negative impact on production costs.

Furthermore, in the upstream laminating step, especially when using highly stretchable materials, there is a risk that individual material plies will already be stretched to different degrees during connection and that these stretches will be fixed in the laminate composite. In the downstream thermal deformation step, these different stretches can have a negative effect on the reproducibility of the deformation, among other things.

The object of the present invention is therefore to provide a method for producing a water-tight, water-vapour-permeable three-dimensional segment, for example of a functional shoe shaft laminate, whereby the disadvantages of the prior art are at least reduced. Furthermore, the object is to provide such a three-dimensional, water-tight and water-vapour-permeable segment of, for example, a functional shoe shaft laminate.

The problem posed according to the invention is solved by a method for producing a water-tight, water-vapour-permeable segment, having a three-dimensional contour, for a shoe shaft, an item of clothing or a rucksack or for forming the same, the segment being free of connection points in its surface, and the method comprising the following steps:

a. Presentation of a stack of at least one first and one second two-dimensional sheet structures arranged one on top of the other, whereby at least two sheet structures contained in the stack adjacent to one another and lying directly on top of one another are not connected to one another and whereby the first sheet structure forms a water-tight, water vapour-permeable functional layer,

b. Presentation of a mould body comprising said three-dimensional contour,

c. Thermoforming of the stack of at least a first and a second sheet structure by means of the mould body and simultaneous lamination of the sheet structures contained in the stack, resulting in an adhesion of at least 1.0 N, measured according to DIN 53530:1981-02 with a test piece width of 25 mm, between at least one first and one second two-dimensional sheet structures arranged one on top of the other and not originally connected to one another, with heating of the stack to a process temperature, whereby the process temperature is to be set in such a way that plastic deformation of the stack and lamination for planar connection of the two-dimensional sheet structure contained in the stack is obtained, whereby the segment is formed.

The method according to the invention has at least the advantages over the prior art that
the segment can be obtained by means of a simple forming process.
by using several individual sheet structures instead of a prefabricated overall laminate, otherwise necessary upstream process steps for connecting/laminating individual sheet structures can be at least partially dispensed with.
the use of several individual sheet structures instead of a prefabricated overall laminate enables a swifter response to individual customer requirements and, if necessary, a reduction in storage capacity that would otherwise have to be kept available to enable a wide variety of laminate designs.
the materials in the two-dimensional sheet structures can be combined more freely in terms of sequence and/or selection.
the process results in a maximum exchange surface for water vapour.
wear comfort is increased by avoiding pressure points due to seams and avoiding wrinkles.
the stretching and deformation of the two-dimensional sheet structures and functional layer(s) increases the breathability of the individual materials or the resulting overall laminate as compared to an otherwise identically constructed, non-deformed overall laminate.
elasticities and restoring forces between the sheet structures are reduced or even prevented by the simultaneous deformation and lamination of the sheet structures that are not connected to each other, whereby the segment to be produced is more dimensionally stable than the segments of the prior art.

In the context of the invention, the following terms are defined and used throughout the description:

The term “free of connection points” is to be understood as meaning that the surface of a segment does not have any connection points created by sewing, welding, gluing or other connection methods known to the person skilled in the art.

“Plastic deformation of the stack” is to be understood to mean at least the plastic deformation of a part of the two-dimensional sheet structures contained in the stack at the process temperature set in the thermoforming step, so that after cooling of the stack, the segment obtained is fixed in its three-dimensional contour according to the invention.

A “segment” can be introduced into a three-dimensional shoe shaft or used to produce it. Furthermore, a segment can also be introduced into or form an item of clothing or a rucksack. Where the segment is introduced into or forms a three-dimensional shoe shaft, the segment may include all foot-facing portions of a shoe. These areas may include the sole below the foot and the sub-areas of the toe cap, toe blade, quarter and rear cap. These sections, with the exception of the sole, are also referred to as the inner shaft. It is also possible for the segment only to include some of the areas facing the foot, e.g. the area of the sole can be left out of the segment. In this case, the segment can be introduced into a shoe shaft, but the segment does not belong to the shoe shaft material (outer shaft) of the shoe (e.g. leather), but is located inside the shoe in the area of the inner shaft.

Furthermore, it is possible for the segment to include the upper/outer material of the shoe shaft in addition to the sheet structures facing the foot (inner shaft), thereby forming at least parts of the entire shaft. This means that the segment can not only be introduced into a shoe as an inner shoe shaft, but can also form the entire shoe shaft. The segment according to the invention can completely enclose the foot, but can also be open in the sole area, for example, in order to be connected to a suitable sole.

If the segment is introduced into an item of clothing, it can make up the individual components of the item of clothing facing the body. For example, it is possible for the segment to replicate the shape of a glove, with the shape including the individual fingers, the palm and the back of the hand. Furthermore, the segment can also form an entire item of clothing. The segment could also be introduced into socks or headgear, for example hats, caps or also caps, or form them entirely. The segment may take the form of the entire headgear or only parts of it, for example in the case of a cap where the main part, the crown, contains the segment but not the visor. Furthermore, the segment according to the invention has a three-dimensional contour and is thus a three-dimensional segment.

The stack presented in the method according to the invention comprises at least a first and a second two-dimensional sheet structure arranged one on top of the other. The plies contained in the presented stack may be laminated, i.e. connected to each other. In any case, however, the stack contains two adjacent two-dimensional sheet structures that are not connected to each other. The two-dimensional sheet structures that are adjacent to each other and lie directly on top of each other are not connected to each other. However, the stack can also include other two-dimensional sheet structures that are not connected to a respective adjacent and directly superimposed sheet structure. Ultimately, the stack can also be made up entirely of two-dimensional sheet structures that are not connected to each other.

In the context of the present invention, “laminating” is understood to mean that two-dimensional sheet structures contained in the stack are connected to each other in a planar manner.

The term “connected in a planar manner” defines that at least two two-dimensional sheet structures or plies are connected to each other at their surfaces formed in their planar extension to form a two-dimensional planar laminate. The planar connection can be made in such a way that the elements are connected across their entire surface, i.e. in a full-surface manner. The surfaces can also be connected to each other at points, whereby the point connections are subject to a pattern and can be, for example, adhesive dots distributed in a grid pattern.

The term “ply” describes a two-dimensional layer that can be present as a contiguous (continuous) or also as a non-contiguous (discontinuous) layer. A contiguous layer can be, for example, a textile ply. A non-contiguous layer can, for example, be a pattern in the form of adhesive dots, flakes, etc. This pattern can, for example, be printed on the side of the functional layer facing away from the foot. In textile technology, this is called a half-ply; in combination with the functional layer and a textile ply facing the foot, it is called a 2.5-ply laminate.

The terms “bootie” and “functional sock” describe shoe components that completely enclose a wearer's foot.

The term “textile ply” describes a ply consisting of a textile. This textile can take various forms, for example the form of a woven fabric, a knitted fabric, a crocheted fabric, a non-woven fabric, a braided fabric, a non-crimp fabric or a felt.

The term “functional layer” describes a ply that has at least one function, namely at least the basic functions of waterproofing and water vapour permeability. This functional layer can be a foil, a film or a membrane that is both water-tight and water-vapour-permeable. Preferably, the functional layer consists of one or more polymeric materials, which includes both hydrophilic and hydrophobic polymers, as well as combinations and mixtures thereof.

In the context of the present invention, the terms “polymeric material” and “polymers” are used equally and interchangeably. Polymeric material or polymer is understood to mean any synthetic or natural polymer.

An “item of clothing” within the meaning of the invention includes gloves, headgear, socks, jackets, trousers, vests and the like.

The two-dimensional sheet structures of the present invention may comprise a single ply or layer or may comprise multiple plies or layers. Possible plies or layers are textile plies, functional layers or adhesive layers. In the case of a sheet structure with several plies or layers, these plies and/or layers are connected in a planar manner to form a pre-laminate.

In a preferred embodiment of the method according to the invention, the segment is introduced into a three-dimensional shoe shaft, item of clothing or rucksack. Preferred items of clothing are gloves, socks and headgear such as hats, caps or caps, jackets, trousers and vests. The gloves can be designed in such a way that the fingers are individually enclosed by the glove, which is also called a fingered glove, or that the thumb is enclosed separately from the other fingers, which is also called a mitten.

In a preferred embodiment of the method according to the invention, at least one two-dimensional sheet structure comprises at least one thermoplastic ply or contains at least thermoplastic components.

A thermoplastic ply can be formed as an independent two-dimensional sheet structure or can be a ply within a two-dimensional sheet structure which is a pre-laminate consisting of several plies.

Furthermore, in a preferred embodiment, the thermoplastic components may be components of one ply of a two-dimensional sheet structure.

As explained, it is essential for the method according to the invention that the stack is thermoformed into a three-dimensional shape to form the segment according to the invention and that the two-dimensional sheet structures contained therein are completely laminated together in their entirety.

In the context of the present invention, thermoforming refers to the forming of a stack of two-dimensional sheet structures. The stack may contain at least one thermoplastic ply. The at least one thermoplastic ply may be, for example, a thermoplastic film, a suitable textile comprising a thermoplastic material, or films or non-wovens consisting of hot-melt adhesive. In thermoforming, the two-dimensional sheet structures are heated to a temperature that permits plastic deformation of the at least one thermoplastic ply and are converted into a three-dimensional contour by means of a rigid mould body or a mould body that is movable in itself during the thermoforming process and has a three-dimensional contour. At the same time, in the method according to the invention, the at least one thermoplastic ply must develop a stickiness due to the heating, so that it laminates the two-dimensional sheet structures contained in the stack with one another in the three-dimensional segment or connects them to each other in a planar manner.

Preferably, the at least one thermoplastic ply comprises a thermoplastic material having a melting temperature of from 80 to 270° C., measured according to DIN EN ISO 11357-1 and -3.

Further preferably, the at least one thermoplastic ply comprises a thermoplastic material having a glass transition temperature of from 0 to 220° C., measured according to DIN EN ISO 11357-1 and -3.

In a preferred embodiment of the method according to the invention, the at least one thermoplastic ply comprises at least one material selected from a group consisting of polyurethane (PU), polyolefin (PO), polyester (PES), Polyether ester (PEEST), polyacrylonitrile (PAN), polyamide (PA), polyacrylate (PAC), polyether imide (PEI), polytetrafluoroethylene (PTFE), polysulfone (PSU), cellulose acetate (CA) and their block or random copolymers and/or mixtures thereof.

The mould body with a three-dimensional contour may have a negative shape, for example a hollow body open on one side, or a positive shape, which may be a complete three-dimensional mould body or part thereof.

In preferred embodiments of the method according to the invention, the transfer of the stack of two-dimensional sheet structures into the three-dimensional contour and the simultaneous lamination can be assisted means of a vacuum and/or compressed air and/or a counter tool. In a preferred embodiment of the process with vacuum support, the vacuum is applied between the mould body and the stack of two-dimensional sheet structures.

In a further embodiment according to the invention, thermoforming is assisted by applying a vacuum between the mould body and the stack or the deformed stack.

After the stack of at least two two-dimensional sheet structures has been transferred into the three-dimensional contour and laminated at the same time, cooling is performed so as to fix the three-dimensional contour of the three-dimensional segment obtained. Cooling can also be carried out by means of a cooled mould body or supported by the latter.

The mould body and the resulting three-dimensional segment are then separated from each other. The three-dimensional segment obtained in this way can subsequently be subjected to further processing.

Despite the fixation by cooling of the segment obtained, the shape may still change slightly due to elasticity or resetting of the contained materials. A change in shape is considered minor in connection with the method according to the invention if the deviation of the contour of the, for example, deformed functional shoe shaft laminate from the contour specified by the positive or negative mould is a maximum of ±25%. Accordingly, the three-dimensional segment is considered dimensionally stable if it undergoes only a maximum change of ±25% in the specified contour under its own weight. In the method according to the invention, at least some of the two-dimensional sheet structures are not connected to each other, which is why the two-dimensional sheet structures can move with a certain freedom relative to each other during the deformation applied as part of the method. Without being bound by theory, it is assumed that this will reduce elasticity and resetting forces and thereby achieve a change in the specified contour of ±5% or less.

The method according to the invention offers the advantage that thermoforming can be carried out continuously with a certain timing of the individual process steps, for example with two-dimensional sheet structures drawn from rolls, which can be constructed from one or more plies and/or layers.

Of course, it is also possible to carry out the procedure discontinuously.

In an advantageous embodiment of the process, thermoforming is assisted by applying a vacuum between the mould body and the stack or the deformed stack.

In a further preferred embodiment of the method according to the invention, thermoforming in step c. comprises the following sub-steps:
Clamping of the stack into a frame,
Heating of the two-dimensional sheet structures contained in the stack from at least one side to the process temperature,
Forming of the segment and laminating of the two-dimensional sheet structures by transferring the stack into the three-dimensional contour by means of the mould body and applying a vacuum between the two-dimensional sheet structure and the mould body,
Cooling of the segment to fix the three-dimensional contour,
Removal of the vacuum,
Removal of the mould body.

Thermoforming can be carried out with a suitable thermoforming machine, for example made by Illig or Kiefel.

In the thermoforming process, the two-dimensional sheet structures are introduced into a thermoforming machine and heated there, for example with the aid of infrared radiators, to a process temperature of between 80° C. and 270° C., preferably between 100° C. and 220° C. and particularly preferably to a process temperature of between 130° C. and 180° C.

Instead of infrared radiators, the stack can be heated by any suitable method, such as induction, microwave irradiation or hot air. However, heating the stack by means of infrared radiators is preferred.

Preferably, the stack is heated for 5 to 60 seconds.

Particularly preferably, the stack of at least two two-dimensional sheet structures is heated on both sides. By heating the stack on both sides, the two-dimensional sheet structures contained are heated evenly, which can lead to better lamination and better adhesion between the plies. As a result, the two-dimensional sheet structures laminated together can have an advantageous adhesion of at least 1.0 N, whereby the two-dimensional sheet structures preferably have an adhesion of at least 3.0 N, even more preferably of at least 3.5 N and particularly preferably of at least 4.0 N, measured according to DIN 53530:1981-02 with a test piece width of 25 mm. An upper limit for the adhesion results if a tearing of at least one of the two-dimensional sheet structures occurs during the test before a separation of the plies.

During heating or after heating, the heated pile can be re-tensioned. The re-tensioning can be carried out mechanically by fixing the stack in the thermoforming machine, or by using active media such as compressed air.

After heating and, if necessary, re-tensioning, in one embodiment of the method, the mould body with the desired three-dimensional contour can be moved, for example, from below through the plane of the heated stack in order to roughly predefine the three-dimensional contour.

Thereupon, as explained, in a preferred embodiment of the method, a vacuum can be created between the mould body and the two-dimensional sheet structure so that the desired three-dimensional contour is completely formed from the two-dimensional sheet structures contained in the stack and these are laminated together to obtain the segment of a three-dimensional functional laminate, for example for introduction into a shoe shaft, an item of clothing or a rucksack, or for the production of a shoe shaft.

Preferably, thermoforming by means of the mould body is carried out with a dwell time of the stack on the mould body in the range of 1 to 30 seconds.

When using a vacuum between the mould body and the two-dimensional sheet structure, a pressure of 0.001 to 0.95 bar is used, preferably a pressure of at most 0.8 bar, further preferably a pressure of at most 0.6 bar and particularly preferably a pressure of at most 0.4 bar.

The segment is then preferably cooled to fix the three-dimensional contour. Cooling can be achieved by a cooled mould body or by external cooling, for example by air or other suitable methods known to the person skilled in the art. Preferably, cooling is carried out within 5 to 45 seconds.

The method may comprise a subsequent step of cutting or punching the segment out of the formed sheet structure.

A preferred embodiment of the method is that the thermoforming and laminating comprises deep drawing with forming tools, deep drawing with active media, deep drawing with active energy or combinations thereof.

Deep drawing with forming tools can also constitute an embodiment in which a mould body with a three-dimensional contour is moved, for example, through the plane of the stack from below. To support the deformation, a counter tool can additionally be pressed onto the stack from the side of the stack facing away from the mould body. In this case, the counter tool has a three-dimensional counter contour adapted to the moulded part.

In the case of deep drawing with active media, the thermoforming is supported by active media such as compressed air or a pressure-regulated fluid cushion.

In the case of deep drawing by means of active energy, forming can be achieved by magnetic forces. However, this requires the presence of sheets or threads that conduct electricity well.

A preferred embodiment of the method is that during thermoforming, additional pressure is applied to the surface of the stack facing away from the moulded body to assist in the transfer to the three-dimensional contour.

This additional pressure can be generated by a counter tool, as already explained, by compressed air or a pressure-regulated fluid cushion.

In a preferred embodiment, when an additional pressure is used on the side of the stack facing away from the mould body, a pressure of 1.5 to 10 bar is used, particularly preferably a pressure of 3 to 8 bar and further preferably a pressure of 5 to 7 bar.

In a preferred embodiment of the method according to the invention, the functional layer comprises one or more polymeric materials, preferably one or more thermoplastic materials. The functional layer can consist of a non-porous membrane, a microporous membrane or a combination thereof.

The water-tight and water-vapour-permeable functional layer preferably has a thickness of no more than 200 μm and particularly preferably a thickness of no more than 30 μm.

Furthermore, the functional layer preferably has an elongation at break of at least 50%. Particularly preferably, the functional layer has an elongation at break of at least 200%.

Preferably, the water-tight and water-vapour-permeable functional layer comprises at least one material selected from a group consisting of polyurethane (PU), polyolefin (PO), polyester (PES), polyether ester (PEEST), polyacrylonitrile (PAN), polyamide (PA), polyether imide (PEI), polytetrafluoroethylene (PTFE), polysulfone (PSU), cellulose acetate (CA) and their block or random copolymers and/or mixtures thereof.

In one embodiment, the microporous membrane may be an expanded polytetrafluoroethylene membrane. It is also conceivable that a non-expanded polytetrafluoroethylene film is used before deep drawing which is stretched by deep drawing, whereby the polytetrafluoroethylene film is microporous after the deep drawing process.

In a further embodiment of the method according to the invention, the functional layer comprises both a microporous membrane and a non-porous membrane. Preferably, the microporous membrane comprises a hydrophobic polymeric material, for example polytetrafluoroethylene, and the non-porous membrane comprises a hydrophilic polymeric material, for example a polyurethane. The functional layer can therefore also exhibit a combination of a hydrophobic polymeric material and a hydrophilic polymeric material.

In a preferred embodiment, the water-tight and water-vapour-permeable functional layer is constructed in particular from thermoplastic polyurethanes (TPU) or polyether esters (PEEST).

A non-limiting example of a water-tight and water-vapour-permeable functional layer in the form of a non-porous membrane is the Sympatex® membrane, a membrane made of polyether ester (PEEST) that is harmless to health and recyclable.

In a preferred embodiment of the method according to the invention, the first sheet structure comprises a functional layer.

According to the invention, a two-dimensional sheet structure can consist of multiple plies. Preferably, the at least two two-dimensional sheet structures have at least one further ply.

The functional layer can be provided with at least one further ply on its lower as well as on its upper side within a two-dimensional sheet structure. These can already be connected in a planar manner before thermoforming or not connected in a planar manner until thermoforming is carried out. The functional layer can have the same or different numbers of plies on its lower and upper sides. Preferably, the at least one further ply is a textile ply.

In an advantageous embodiment, the at least one further ply is a textile ply, whereby this textile ply can be constructed continuously or discontinuously in its planar extension. In a preferred embodiment, the textile ply is in the form of a woven fabric, a knitted fabric, a crocheted fabric, a non-woven fabric, a braided fabric, a non-crimp fabric or a felt. Preferably, the stack comprises at least one textile ply.

In a preferred embodiment of the method according to the invention, the first sheet structure is a pre-laminate comprising a functional layer and at least one further ply, which are connected by means of a hot-melt adhesive or a reactive adhesive, the adhesive being applied continuously or discontinuously to the functional layer and/or the at least one further ply.

In another preferred embodiment, the at least one further ply may be applied to the functional layer in the form of a flocking. In yet another preferred embodiment, the at least one further ply is discontinuous and may, for example, have a pattern, e.g. of adhesive dots applied in a grid pattern or a flocking applied in a grid pattern, for example in the form of domains, whereby the individual dots or domains are not connected to one another.

Preferably, the textile plies can have different areas that include, for example, local reinforcements and/or different degrees of stretchability. The textile plies can also have anisotropic areas in which different properties are present in the directions of extension of the textile ply. These local differences and/or anisotropies in the textile plies can, for example, be incorporated in the textile plies by certain weaving processes and knitting methods. The different areas obtained in this way can serve, for example, as reinforcements in the heel area, at the toe or the lacing elements or to support the formation of the most accurate possible impression of the desired shape contour in the thermoforming process. In a preferred embodiment of the method according to the invention, the textile ply has areas with different properties and/or anisotropic areas.

In a further preferred embodiment of the method, the textile plies may be composed of yarns or filaments. Yarns can be multi-filament yarns, but also yarns made from staple fibres. In this context, the person skilled in the art understands staple fibres to be relatively short fibres with a length of 2 to 200 mm. Filaments, on the other hand, have a length of more than 200 mm, preferably more than 500 mm, even more preferably more than 1,000 mm. Filaments can also be practically endless if, for example, they are continuously extruded through spinnerets during spinning.

The yarns or filaments of the textile plies can consist of a single polymer or of several polymers. In the latter case, the yarns may be blended yarns, with the individual filaments comprising different polymers, or the filaments may be bi-component filament yarns, with the individual filaments comprising more than one polymer.

Such bi-component filament yarns contain more than one polymer in a spatially limited arrangement, for example as a side-by-side model, core-sheath model or island-in-the-sea model.

Another embodiment of the method is that the filaments of the textile plies consist of bi-component filament yarns with the core-sheath model, whereby the melting temperature T_{M, sheath} of the polymer in the sheath is lower than the melting temperature T_{M, core} of the polymer in the core.

In a preferred embodiment, the material of the textile ply is selected from a group of polymers comprising polyolefins, polyesters, polyamides, polyurethanes and polyacrylonitriles or a combination thereof.

Preferably, the polymers have a glass transition temperature of 20 to 220° C., measured according to DIN EN ISO 1 1357-1 and -3.

Further preferably, the polymers have a melting temperature of 80 to 270° C., measured according to DIN EN ISO 1 1357-1 and -3.

Furthermore, the two-dimensional sheet structures preferably have an elongation at break in the longitudinal and transverse directions of 50 to 360% at room temperature, measured according to DIN EN ISO 13934-1:1999. In a preferred embodiment of the method according to the invention, the two-dimensional sheet structures preferably have an elongation at break in the longitudinal or transverse direction of at least 50%, more preferably of at least 100% and even more preferably of at least 250% at room temperature.

In addition, the two-dimensional sheet structures preferably have a tensile strength of 60 to 1700 N in the longitudinal and transverse directions, measured according to DIN EN ISO 13934-1:1999.

Preferably, the functional layer can be connected to one of the at least one further ply by means of a hot-melt adhesive or a reactive adhesive, whereby the adhesive can be applied continuously or discontinuously to the functional layer and/or the at least one further ply.

It is also possible to build up a continuous or discontinuous ply consisting of hot melt or reactive adhesive, for example in the form of non-woven fabrics or other structures.

In the case of the preferred use of textile plies, these may comprise a hot-melt adhesive or reactive adhesive. For example, the textile plies can consist entirely or partially of a hot-melt adhesive or reactive adhesive. This includes the textile ply-building polymer or a polymer contained in the textile plies acting as a reactive adhesive or hot-melt adhesive.

In this case, there is the possibility of creating a connection between the functional layer and the textile ply by transferring this polymer into its softening range or beyond. Of course, such a textile ply can also be combined with another continuous or discontinuous ply in this way.

In one embodiment of the method according to the invention, the at least one further ply is a textile ply comprising a hot-melt adhesive or a reactive adhesive, by means of which the functional layer and the textile ply are connected to one another in a planar manner.

In general, any suitable polymer, copolymer or mixture thereof can be used as a hot melt or reactive adhesive. Preferably, a polymer selected from a group consisting of polyurethane (PU), polyamide (PA), polyester (PES), thermoplastic polyurethane (TPU), polyacrylate (PAC) or their block or random copolymers and/or mixtures thereof is used as the hot-melt adhesive or reactive adhesive.

In a preferred embodiment of the method according to the invention, the polymers of the reactive adhesives or the hot-melt adhesives have a melting temperature of 70° C. to 220° C., measured according to DIN EN ISO 11357-1 and -3.

In a likewise preferred embodiment, the polymers of the reactive adhesives or the hot-melt adhesives have a glass transition temperature of 10° C. to 220° C., measured according to DIN EN ISO 11357-1 and -3.

The polymer of the reactive adhesive or hot-melt adhesive used to connect the plies in a pre-laminate is preferably selected to have a melting temperature above the process temperature during deep drawing.

In some cases, however, the polymer of the reactive adhesive or hot-melt adhesive used to connect the plies in a pre-laminate is also preferably selected to have a melting temperature below the process temperature during deep drawing. By melting the adhesive during deep drawing, for example, it is possible to achieve a sliding together of the plies originally connected in the pre-laminate and a renewed connection of the plies after shaping and cooling, and thereby at least reduce any strains that might otherwise occur in the three-dimensional segment of a functional laminate.

The polymer of the reactive adhesive or hot-melt adhesive used to laminate the two-dimensional sheet structures during deep drawing is preferably selected to have a melting temperature below the process temperature during thermoforming.

A preferred embodiment of the method is that, when the two-dimensional sheet is presented, a cover foil is placed on the surface of the stack facing away from the mould body during thermoforming, which is removed after thermoforming.

The cover foil can be made of different materials, but should preferably be removable from the three-dimensional segment without leaving any residue after thermoforming. In addition, the cover foil should preferably exhibit good thermal conductivity, as well as high temperature resistance and a high softening temperature range. Furthermore, the cover foil should be easily stretchable and exhibit a stretchability of at least the same order of magnitude as the stretchability of the two-dimensional sheet structure. An example of such cover foils are silicone foils.

The cover foil can be used to maintain the vacuum during thermoforming, i.e. to seal it off from the outside. This is particularly advantageous when using additional plies outside an air-impermeable functional layer or when using an air-permeable microporous membrane as a functional layer. Furthermore, this cover foil can serve as a separating film to prevent the plies of the two-dimensional multi-ply sheet structure from sticking to the counter tool or to the pressure-regulated fluid pad after thermoforming.

In another preferred embodiment of the method, the material of the mould body is selected from a group comprising wood, plastics, fibre-reinforced plastics, polymer resins and aluminium casting resins, plaster, metal, metal alloys, steel, clay, ceramics, glass, hard plastics, cast brass and/or combinations thereof.

Particularly preferably, the material of the mould body is selected from a group comprising wood, plastics, fibre-reinforced plastics, polymer resins, aluminium casting resins and/or combinations thereof.

In a further advantageous embodiment of the method, the mould body exhibits the desired shoe inner contour or the desired hand or cap contour, for example in the form of a shoe last or a hand or head shape.

The method described above is particularly suitable for producing a water-tight and water-vapour-permeable segment of a functional shoe shaft laminate for introduction into a shoe shaft, whereby the segment is at the same time dimensionally stable, of a single piece and free of connection points in its surface.

Therefore, the invention further relates to a water-tight and water-vapour-permeable three-dimensional segment for or for the forming of a shoe shaft, an item of clothing or a rucksack, whereby the segment comprises a water-tight and water-vapour-permeable functional layer and at least one further ply, and the functional layer and/or the at least one further ply comprises a thermoplastic material and whereby the segment is dimensionally stable under its own weight, is of a single piece and is free of connection points in its surface, characterized in that the segment consists of a stack of at least two two-dimensional sheet structures which were simultaneously laminated and transferred to the three-dimensional segment.

In a preferred embodiment of the segment according to the invention, this segment forms the entire shaft.

This segment exhibits no connection points in its surface. Therefore, the entire segment is water-tight and water-vapour-impermeable, without any weak points that require special sealing or reinforcement.

Moreover, the preferred embodiments described above for the method according to the invention, for example with regard to the materials used, their properties and the structures of the segments obtained by means of the method, also apply accordingly to the water-tight and water vapour-permeable three-dimensional segment of a functional laminate according to the invention.

Furthermore, the three-dimensional segment or the three-dimensional segment according to the invention may comprise the entire inner shaft as well as the inner and outer shaft and thereby the entire shaft of a shoe.

The segment produced according to the method of the invention or the segment according to the invention is preferably provided with a sole construction. The segment produced by the method according to the invention or the segment according to the invention can be provided with a sole construction using the shoe-making methods known to the person skilled in the art.

For example, the segment produced according to the method according to the invention or the segment according to the invention may be connected by means of a joining process such as gluing and/or sewing. Of course, all other suitable joining methods, such as laser welding, ultrasonic welding, high-frequency welding and hot-wedge welding and combinations thereof, are also covered by the invention.

The segment according to the invention or the segment produced according to the method according to the invention is preferably sewn to a Strobel sole or pinched to an insole and connected to a sole structure in a water-tight manner with a sealing material and/or by means of an adhesive.

The Strobel method is a way of connecting the shoe shaft to the midsole, mainly for making light hiking and running shoes. The shoe shaft is sewn to a textile insole made of hard-wearing fabric, for example, using what is known as a Strobel seam. The Strobel seam is a circumferential whipped seam between the shoe shaft and the insole. The sole is either glued or injected. The adhesive or the material used for injection penetrates the Strobel seam and seals it.

In the case of pinching, the insole is attached to the underside of the last and then the shoe shaft incl. functional laminate is pulled over the last. The permanent connection between the shaft, functional laminate and insole is made using adhesives.

In addition, the sole construction may also preferably be provided with an outer sole by direct injection with a polymer such as polyurethane, whereby the polymer seals the segment to the sole construction.

During the injection process, the finished shoe shaft including functional laminate is positioned in a sole mould. In this form, the injection is made using a suitable polymer/plastic, usually polyurethane. The polymer mass penetrates the Strobel seam and seals it.

The invention is explained in more detail with reference to the following figures and examples, although the figures and examples are not to be understood as restrictive:

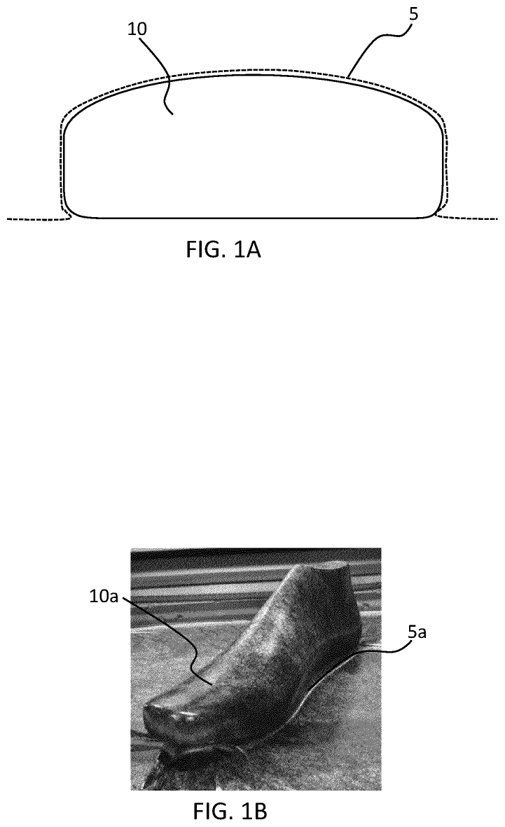

FIG. 1A schematically shows a cross-section of a mould body with a three-dimensional segment according to the invention.

FIG. 1B shows an exemplary photographic image of a side view of a mould body/shoe last with a three-dimensional segment according to the invention enclosing the mould body on its shoe shaft side.

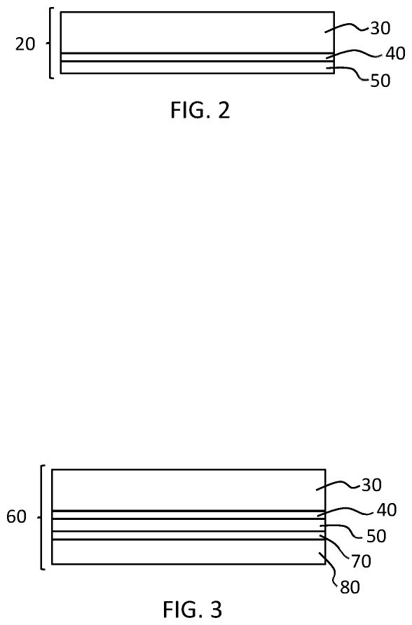

FIG. 2 schematically shows a cross-section of a 2-ply functional shoe shaft laminate according to the invention.

FIG. 3 schematically shows a cross-section of a 3-ply shoe shaft functional laminate according to the invention.

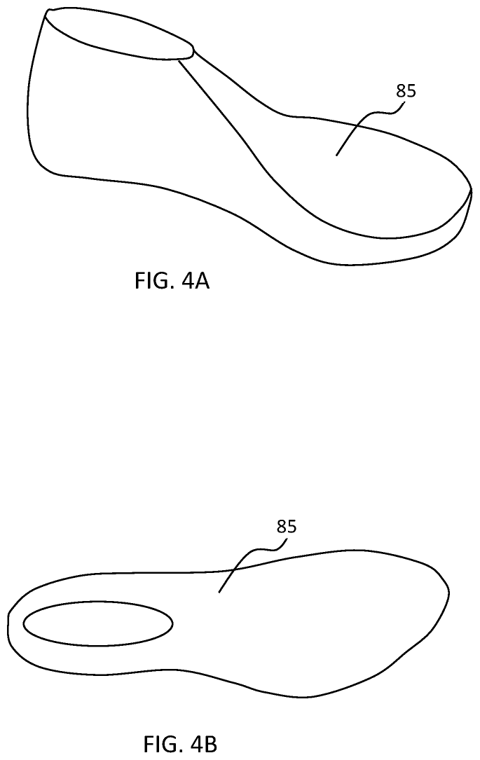

FIG. 4A shows a schematic sketch of a side view of a shoe last commonly used in the footwear industry.

FIG. 4B shows a schematic sketch of a top view of a shoe last commonly used in the footwear industry.

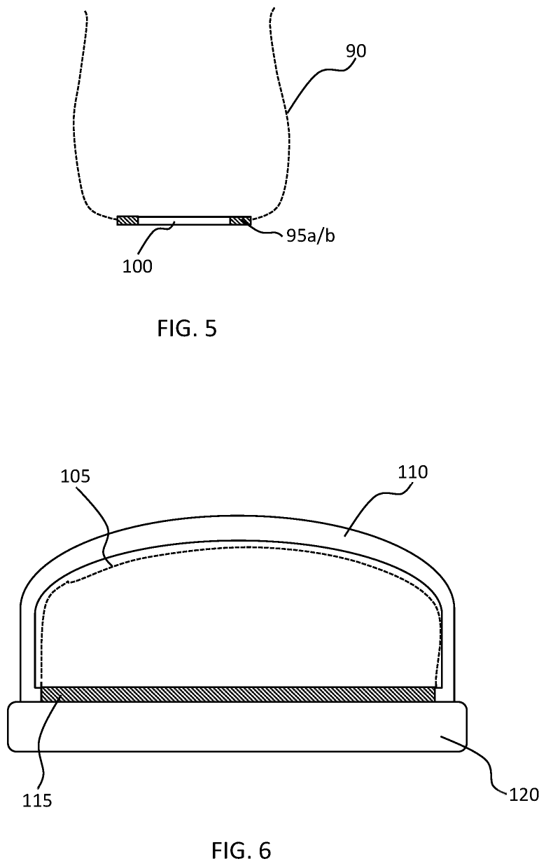

FIG. 5 schematically shows a cross-section of a three-dimensional segment of a functional shoe shaft laminate connected to a sole construction according to the invention.

FIG. 6 schematically shows a cross-section of a shoe containing a three-dimensional segment of a functional shoe shaft laminate according to the invention.

FIGS. 1A and 1B schematically illustrate in cross-section (FIG. 1A) or by means of an exemplary photographic illustration (FIG. 1B) the result of the deformation, carried out according to the method of the invention, of a two-dimensional sheet structure to form a suitable three-dimensional segment of a functional shoe shaft laminate 5 or 5a using a mould body 10 or 10a, which provides the three-dimensional contour of the segment 5 or 5a.

FIG. 2 schematically shows a cross-section of a section of a three-dimensional segment 20 formed and laminated according to the method of the invention, which is composed of a textile ply 30, an adhesive layer 40 and a water-tight and water-vapour-permeable functional layer 50. In an advantageous embodiment, the functional layer 50 is made of polyether ester (PEEST), such as a Sympatex® membrane. In a preferred embodiment, the adhesive layer 40 may also be a non-woven fabric comprising fibres or filaments containing the adhesive. The segment in this embodiment can thus also be considered a 3-ply functional shoe shaft laminate.

By way of an example, FIG. 3 schematically shows a cross-section of a part of a three-dimensional segment 60 deformed and laminated according to the method of the invention, consisting of a first textile ply 30, a first adhesive layer 40, a water-tight and water-vapour-permeable functional layer 50, a second adhesive layer 70 and a second textile ply 80. The textile plies 30 and 80 can be identical or different. The same applies to the adhesive layers 40 and 70, irrespective of the textile plies. As described for FIG. 2, the adhesive layers 40 and 70 can also each be a non-woven fabric consisting of fibres or filaments containing the adhesive. The segment in this embodiment can thus also be considered a 5-ply functional shoe shaft laminate.

FIGS. 4A and 4B schematically show, in a side view and in a top view respectively, an example known to the person skilled in the art of a shoe last 85 reproducing the foot contour as it can be used as a mould body in the method according to the invention.

FIG. 5 schematically shows the three-dimensional segment of a functional shoe shaft laminate 90 according to the invention, which in an advantageous embodiment is connected to a sole structure 100 by adhesion 95a or sewing 95b.

FIG. 6 schematically shows a cross-section of a three-dimensional segment of a functional shoe shaft laminate 105 according to the invention in a water-tight and water-vapour-permeable shoe with an outer material 110 (e.g. made of leather), an attached sole construction 115 and an outer sole 120. The segment produced according to the method according to the invention or the segment 105 according to the invention reproduces the shoe contour in optimum fashion so that no gaps or only small ones occur between the outer material 110 and the segment 105 comprising at least parts of the inner shaft. This ensures an optimum fit of the shoe.

### EXAMPLE 1

A stack consisting of a pre-laminate, a thermoplastic adhesive layer and a lining material, whereby the pre-laminate consists of:

1. a knitted fabric of 81% by weight polyethylene terephthalate and 19% by weight elastane, weighing 50 g/m²,

2. a reactive, moisture-curing polyurethane adhesive applied in a grid pattern and weighing approx. 12 g/m²,

3. a polyether ester-based Sympatex® membrane with a membrane thickness of 10 μm,

the adhesive layer (adhesive non-woven) is composed of a non-woven of a thermoplastic adhesive made of polyurethane with a melting range of approx. 115° C. and a weight of 20 g/m² and the lining material is a knitted fabric made of polyester with a weight of 265 g/m².

The pre-laminate, adhesive non-woven and lining material are unrolled from rolls and positioned on a thermoforming machine (Illig) in such a way that the knitted fabric side of the pre-laminate and the lining material face the two infrared heaters of the machine, each set to 175° C., and the stack is heated there for 16-18 seconds. The upright last is then moved through the plane of the stack from below by positive mould formation. The lining material side of the stack faces the last, the knitted side faces away from the last. After reaching the end position, a vacuum is created between the last and the laminate. Here, the stack is formed into a 3D functional shoe shaft laminate and the pre-laminate and lining material are connected to each other by the adhesive non-woven. After a cooling time of approx. 15 s, the vacuum is released, the last is moved down again and the finished 3D functional shoe shaft laminate is removed from the machine.

The finished 3D functional shoe shaft laminate has an adhesion of 2.3 N, measured according to DIN 53530:1981-02 with a test piece width of 25 mm.

### EXAMPLE 2

Example 1 was repeated with the modification that the adhesive non-woven is now part of the pre-laminate. Therefore:

A stack consisting of a pre-laminate and a lining material, the pre-laminate consisting of:

1. a knitted fabric of 81% by weight polyethylene terephthalate and 19% by weight elastane, weighing 50 g/m²,

2. a reactive, moisture-curing polyurethane adhesive applied in a grid pattern and weighing approx. 12 g/m²,

3. a polyether ester-based Sympatex® membrane with a membrane thickness of 10 μm,

4. a non-woven of a thermoplastic adhesive (adhesive non-woven) made of polyurethane with a melting range of approx. 115° C. and a weight of 20 g/m²,

and the lining material is a knitted polyester fabric weighing 265 g/m².

The pre-laminate and lining material are unrolled from rolls and positioned on a thermoforming machine (Illig) in such a way that the knitted fabric side of the pre-laminate faces the two infrared heaters of the machine, each set to 175° C., and is heated there for 16-18 seconds. The upright last is then moved through the plane of the stack from below by positive mould formation. The lining material side of the stack faces the last, the knitted side faces away from the last. After reaching the end position, a vacuum is created between the last and the laminate. Here, the stack is formed into a 3D functional shoe shaft laminate and the pre-laminate and lining material are connected to each other by the adhesive non-woven. After a cooling time of approx. 15 s, the vacuum is released, the last is moved down again and the finished 3D functional shoe shaft laminate is removed from the machine.

The 3D functional shoe shaft laminate has an adhesion of 4.0 N, measured according to DIN 53530:1981-02 with a test piece width of 25 mm.

### EXAMPLE 3

Example 1 was repeated with the modification that the lining material is made from recycled material. Therefore:

A stack comprising the pre-laminate from Example 1, a thermoplastic adhesive layer from Example 1 and a lining material which is a knitted pile of recycled polyester weighing 350 g/m².

The pre-laminate, adhesive non-woven and lining material are unrolled from rolls and positioned on a thermoforming machine (Illig) in such a way that the knitted fabric side of the pre-laminate and the lining material face the two infrared heaters of the machine, each set to 165° C., and are heated there for 16-18 seconds. The upright last is then moved through the plane of the stack from below by positive mould formation. The lining material side of the stack faces the last, the knitted side faces away from the last. After reaching the end position, a vacuum is created between the last and the laminate. Here, the stack is formed into a 3D functional shoe shaft laminate and the pre-laminate and lining material are connected to each other by the adhesive non-woven. After a cooling time of approx. 15 s, the vacuum is released, the last is moved down again and the finished 3D functional shoe shaft laminate is removed from the machine.

The finished 3D functional shoe shaft laminate has an adhesion of 2.1 N, measured according to DIN 53530:1981-02 with a test piece width of 25 mm.

### COMPARISON EXAMPLE 4

Example 1 was repeated with the modification that the adhesive layer is now an adhesive net. Therefore:

A stack consisting of the pre-laminate from Example 1, a thermoplastic adhesive layer consisting of a net of a thermoplastic adhesive made of polyurethane with a melting range of about 110° C. and a weight of 35 g/m² and the lining material from Example 1.

The pre-laminate, adhesive net and lining material are unrolled from rolls and positioned on a thermoforming machine (Illig) in such a way that the knitted fabric side of the pre-laminate and the lining material face the two infrared heaters of the machine, each set to 175° C., and are heated there for 16-18 seconds. The upright last is then moved through the plane of the stack from below by positive mould formation. The lining material side of the stack faces the last, the knitted side faces away from the last. After reaching the end position, a vacuum is created between the last and the laminate. Here, the stack is formed into a 3D functional shoe shaft laminate and the pre-laminate and lining material are connected to each other by the adhesive non-woven. After a cooling time of approx. 15 s, the vacuum is released, the last is moved down again and the finished 3D functional shoe shaft laminate is removed from the machine.

In the finished 3D functional shoe shaft laminate, detachment sometimes occurs within the laminate composite due to uneven distribution of the thermoplastic adhesive. In the area of these points, the adhesion is <1.0 N, measured according to DIN 53530:1981-02 with a test piece width of 25 mm.

### COMPARISON EXAMPLE 5

Example 1 was repeated with the modification that the adhesive non-woven now has a lower melting point. Therefore:

A stack consisting of the pre-laminate from Example 1, a thermoplastic adhesive layer of a non-woven of a thermoplastic adhesive (adhesive non-woven) made of polyurethane with a melting range of about 50° C. and a weight of 20 g/m² and the lining material from Example 1.

The pre-laminate, adhesive non-woven and lining material are unrolled from rolls and positioned on a thermoforming machine (Illig) in such a way that the knitted fabric side of the pre-laminate and the lining material face the two infrared heaters of the machine, each set to 140° C., and are heated there for 16-18 seconds. The upright last is then moved through the plane of the stack from below by positive mould formation. The lining material side of the stack faces the last, the knitted side faces away from the last. After reaching the end position, a vacuum is created between the last and the laminate. Here, the stack is formed into a 3D functional shoe shaft laminate and the pre-laminate and lining material are connected to each other by the adhesive non-woven. After a cooling time of approx. 15 s, the vacuum is released, the last is moved down again and the finished 3D functional shoe shaft laminate is removed from the machine.

In the finished 3D functional shoe shaft laminate, detachment sometimes occurs within the laminate composite due to uneven distribution of the thermoplastic adhesive. In the area of these points, the adhesion is <1.0 N, measured according to DIN 53530:1981-02 with a test piece width of 25 mm.

The comparative examples described above show that simultaneous deformation and lamination in the thermoforming process is crucial in order to achieve the adhesion between the unconnected sheet structures in the functional laminate required according to the invention.

1. Method for producing a water-tight, water-vapour-permeable segment, having a three-dimensional contour, for a shoe shaft, an item of clothing or a rucksack or for forming the same, the segment being free of connection points in its surface, and the method comprising the following steps:
a. presentation of a stack of at least one first and one second twat dimensional sheet structures arranged one on top of the other, whereby at least two sheet structures contained in the stack adjacent to one another and lying directly on top of one another are not connected to one another and whereby the first sheet structure forms a water-tight, water vapour-permeable functional layer,
b. presentation of a mould body comprising the three-dimensional contour,
c. thermoforming of the stack of at least a first and a second sheet structure by means of the mould body and simultaneous lamination of the sheet structures contained in the stack, resulting in an adhesion of at least 1.0 N, measured according to DIN 53530:1981-02 with a test piece width of 25 mm, between at least one first and one second two-dimensional sheet structures arranged one on top of the other and not originally connected to one another, with heating of the stack to a process temperature, whereby the process temperature is to be set in such a way that plastic deformation of the stack and lamination for planar connection of the two-dimensional sheet structure contained in the stack is obtained, whereby the segment is formed.

2. Method according to claim 1, whereby at least on two-dimensional sheet structure contains at least one thermoplastic ply or at least thermoplastic components.

3. Method according to claim 1, whereby thermoforming is assisted by applying a vacuum between the mould body and the stack or the deformed stack.

4. Method according to claim 1, whereby the thermoforming comprises deep drawing with forming tools, deep drawing with active media deep drawing with active energy, or combinations thereof.

5. Method according to claim 1, whereby the functional layer comprises a non-porous membrane, a microporous membrane, or a combination thereof.

6. Method according to claim 5, whereby the functional layer comprises at least one material selected from a group consisting of polyurethane (PU), polyolefin (PO), polyester (PES), polyether ester (PEEST), polyacrylonitrile (PAN), polyamide (PA), polyether imide (PEI), polytetrafluoroethylene (PTFE), polysulfone (PSU), cellulose acetate (CA) and their block or random copolymers and/or mixtures thereof.

7. Method according to claim 1, whereby the stack comprises at least one textile ply.

8. Method according to claim 7, whereby the textile ply comprises areas with different properties and/or anisotropic areas.

9. Method according to claim 7, whereby the material of the textile ply is selected from a group of polymers comprising polyolefins, polyesters, polyamides, polyurethanes and polyacrylonitriles or a combination thereof.

10. Method according to claim 1, whereby the first sheet structure comprises a functional layer.

11. Method according to claim 1, whereby the first sheet structure is a pre-laminate comprising a functional layer and at least one further ply, which are connected by means of a hot-melt adhesive or a reactive adhesive, the adhesive being applied continuously or discontinuously to the functional layer and/or the at least one further ply.

12. Method according to claim 1, whereby the at least one further ply is a textile ply comprising a hot-melt adhesive or a reactive adhesive, by means of which the functional layer and the textile ply are connected to one another in a planar manner.

13. Method according to claim 1, whereby the two-dimensional sheet structures have an elongation at break of at least 50% in their directions of extension at room temperature, measured according to DIN EN ISO 13934-1:1999.

14. Water-tight and water-vapour-permeable three-dimensional segment for or for the forming of a shoe shaft, an item of clothing or a rucksack, whereby the segment comprises a water-tight and water-vapour-permeable functional layer and at least one further ply, and the functional layer and/or the at least one further ply comprises a thermoplastic material and whereby the segment is dimensionally stable under its own weight, is of a single piece and is free of connection points in its surface, wherein the segment consists of a stack of at least two two-dimensional sheet structures which were simultaneously laminated with an adhesion of at least 1.0 N, measured according to DIN 53530:1981-02 with a test piece width of 25 mm, and transferred to the three-dimensional segment.

15. The segment according to claim 14, whereby it comprises the entire shaft of a shoe.
